(19) United States
(12) Patent Application Publication
(10) Pub. No.: US 2025/0307555 A1
(43) Pub. Date: Oct. 2, 2025

(54) INFORMATION EXTRACTION

(71) Applicant: Beijing Zitiao Network Technology Co., Ltd., Beijing (CN)

(72) Inventors: Zuhang Li, Beijing (CN); Jianyu Li, Beijing (CN); Jin Li, Beijing (CN); Yajie He, Beijing (CN); Ke Xu, Beijing (CN); Jian Liu, Beijing (CN)

(21) Appl. No.: 19/053,393

(22) Filed: Feb. 13, 2025

(30) Foreign Application Priority Data
Mar. 29, 2024 (CN) 202410382444.X

(51) Int. Cl. G06F 40/295; G06F 16/3329

(52) U.S. Cl. CPC G06F 40/295; G06F 16/33295

(57) ABSTRACT

Embodiments of the disclosure provide a method, an apparatus, a device and a storage medium for information extraction. The method includes: determining, based on a user input indicating information extraction, a target content and a target structured data object; obtaining structured information of the target structured data object, the structured information indicating at least one field comprised in the target structured data object; determining, based on the target content and the structured information, at least one data item from the target content, the data item corresponding to one or more fields in the at least one field; and adding the at least one data item to corresponding one or more fields in the target structured data object, respectively. Thereby, it is possible to help a user in more efficiently organizing the information in the target content into various carriers.

### CROSS-REFERENCE

The present application claims priority to Chinese Patent Application No. 202410382444.X, filed on Mar. 29, 2024, and entitled “METHOD, APPARATUS, DEVICE AND STORAGE MEDIUM FOR INFORMATION EXTRACTION,” the entirety of which is incorporated herein by reference.

### FIELD

Example embodiments of the disclosure generally relate to the field of computers, and in particular, to information extraction.

### BACKGROUND

With the rapid development of computer technologies, users always have a demand for extracting various content to a structured carrier. For example, as email is widely used, there has long been a need for users to structurally extract mail content into different data tables. For instance, in scenarios such as a purchase application and a bill application, users need to convert the text information in the mail into structured data for further processing.

### SUMMARY

In a first aspect of the present disclosure, a method for information extraction is provided. The method comprises: determining, based on a user input indicating information extraction, a target content and a target structured data object; obtaining structured information of the target structured data object, the structured information indicating at least one field comprised in the target structured data object; determining, based on the target content and the structured information, at least one data item from the target content, the data item corresponding to one or more fields in the at least one field; and adding the at least one data item to corresponding one or more fields in the target structured data object, respectively.

In a second aspect of the present disclosure, an apparatus for information extraction is provided. The apparatus comprises: a determining module configured for determining, based on a user input indicating information extraction, a target content and a target structured data object; an information obtaining module configured for obtaining structured information of the target structured data object, the structured information indicating at least one field comprised in the target structured data object; a data item determination module configured for determining, based on the target content and the structured information, at least one data item from the target content, the data item corresponding to one or more fields in the at least one field; and a data item adding module configured for adding the at least one data item to corresponding one or more fields in the target structured data object, respectively.

In a third aspect of the present disclosure, an electronic device is provided. The device comprises: at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this summary section is not intended to limit the key features or important features of the embodiments of the disclosure, nor is it intended to limit the scope of the disclosure. Other features of the disclosure will become readily understood from the following description.

### BRIEF DESCRIPTION OF DRA WINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

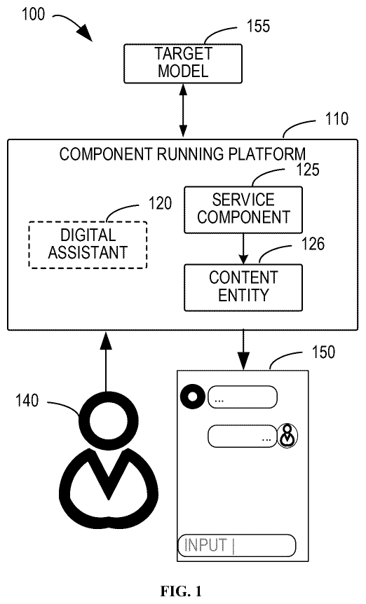

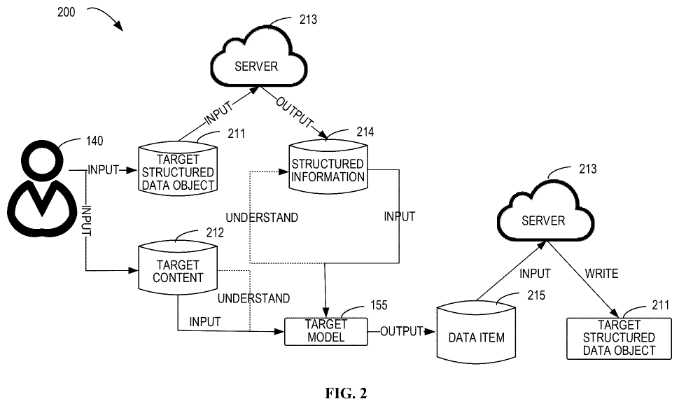

FIG. 1 illustrates a schematic diagram of an example environment in which embodiments of the present disclosure can be implemented;

FIG. 2 illustrates a schematic diagram of an example architecture for information extraction according to some embodiments of the present disclosure;

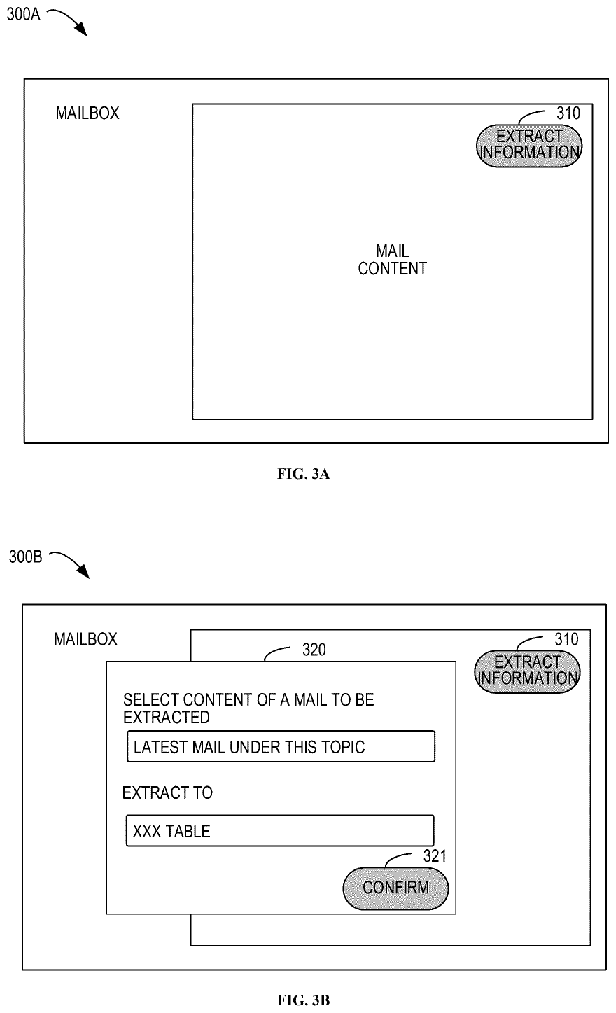

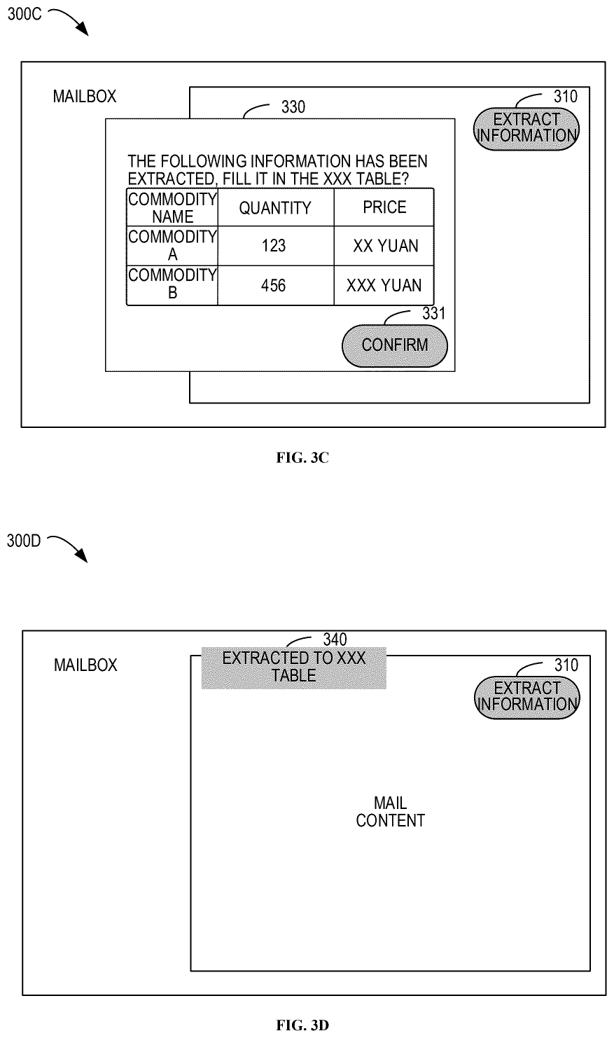

FIGS. 3A-3D illustrate schematic diagrams of example interfaces for designating target content and target structured data objects according to some embodiments of the present disclosure;

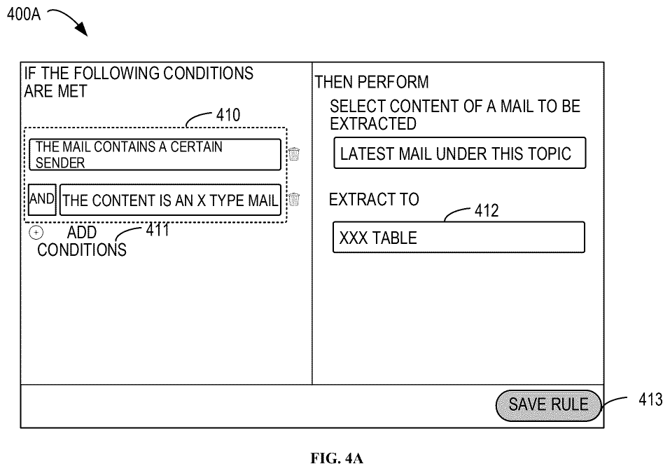

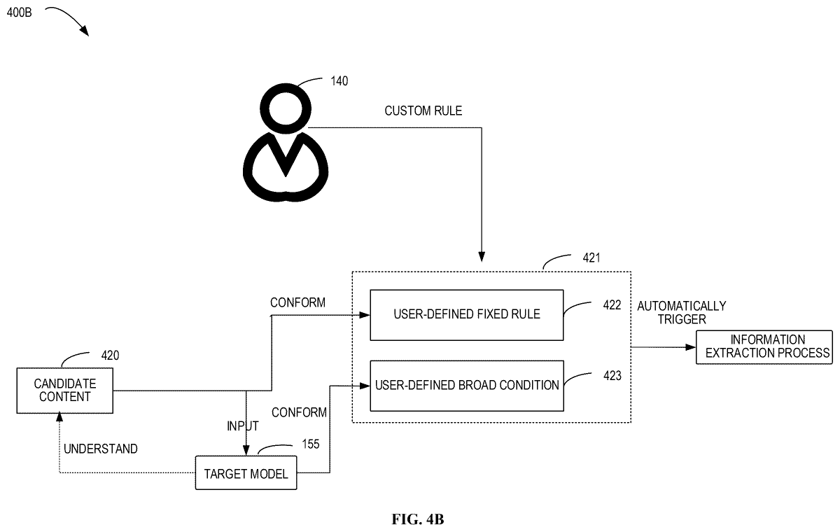

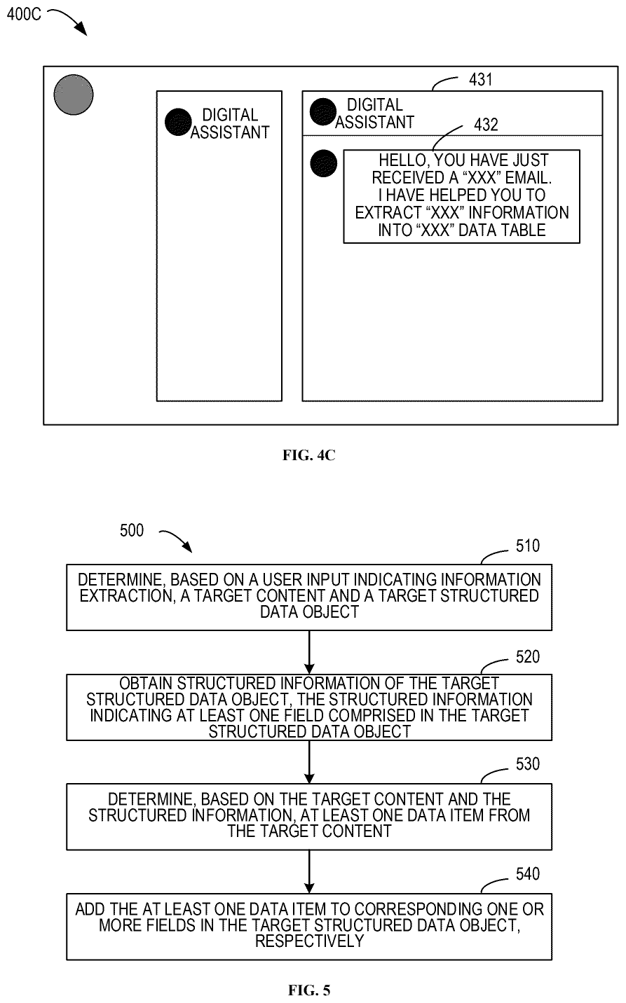

FIG. 4A illustrates a schematic diagram of an example interface for designating information extraction rules according to some embodiments of the present disclosure;

FIG. 4B illustrates a schematic diagram of an example architecture for information extraction according to some other embodiments of the present disclosure;

FIG. 4C illustrates a schematic diagram of an example interface for presenting prompt information according to some embodiments of the present disclosure;

FIG. 5 illustrates a flowchart of a process for information extraction according to some embodiments of the present disclosure;

FIG. 6 illustrates a schematic structural block diagram of an apparatus for information extraction according to some embodiments of the present disclosure; and

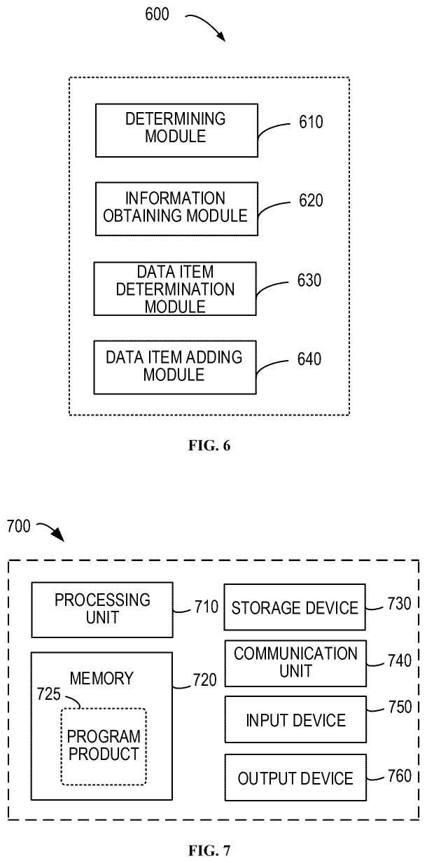

FIG. 7 illustrates a block diagram of a device capable of implementing a plurality of embodiments of the present disclosure.

### DETAILED DESCRIPTION

It may be understood that before using the technical solutions disclosed in the embodiments of the disclosure, the user should be informed of the types, use ranges, usage scenario, and the like of the personal information related to the present disclosure in an appropriate manner according to relevant laws and regulations and the authorization of the user may be obtained.

For example, in response to receiving an active request from a user, prompt information is sent to the user to explicitly prompt the user that the requested operations to be performed would require acquisition and use of personal information of the user, such that the user may autonomously select whether to provide personal information to software or hardware such as an electronic device, an application, a server, or a storage medium that performs the operations of the technical solution of the disclosure, according to the prompt information.

As an optional but non-limiting implementation, in response to receiving an active request from a user, a manner of sending prompt information to the user may be, for example, a pop-up window, and the pop-up window may present the prompt information in a text manner. In addition, the pop-up window may further carry a selection control for the user to select “agree” or “disagree” to provide personal information to the electronic device.

It may be understood that the foregoing process of notifying and acquiring user authorization is merely illustrative, and does not constitute a limitation on the implementations of the disclosure, and other manners that meet related laws and regulations may also be applied to the implementations of the disclosure.

It may be understood that the data involved in the technical solution (including but not limited to the data itself, the obtaining or using of the data) should follow the requirements of the corresponding laws and regulations and related rules.

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or in the different section/subsection.

Herein, unless explicitly stated, “in response to A” performing one step does not imply that this step is performed immediately after “A”, but may include one or more intermediate steps.

In the description of the embodiments of the disclosure, the terms “comprising”, “including” and the like should be understood to open-ended, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As used herein, the term “model” may learn associations between corresponding inputs and outputs from training data, such that after training is complete, a corresponding output may be generated for a given input. The generation of the model may be based on a machine learning technique. Deep learning is a machine learning algorithm that processes inputs and provides corresponding outputs by using a multi-layer processing unit. The “model” may also be referred to herein as “machine learning model”, “machine learning network”, or “network”. These terms are used interchangeably herein. A model may further include various types of processing units or networks.

FIG. 1 illustrates a schematic diagram of an example environment 100 in which embodiments of the present disclosure can be implemented. In this example environment 100, a component running platform 110 can support the operation of a service component 125. A user 140 may interact via a client and the service component 125 of the component running platform 110.

In some embodiments, the service component 125 may be downloaded, installed on a terminal device of the user 140. In some embodiments, the service component 125 may also be accessed in other manners, for example, accessed through a web page. In the environment 100 of FIG. 1, in response to the service component 125 being launched, the client of the component running platform 110 may present an interface 150 of the service component 125.

The service component 125 includes, but is not limited to, one or more of: a chat service component (also referred to as an instant messaging service IM component), a document service component, an audio and video conference service component, a mail service component, a task service component, a calendar service component, an objectives and key results (OKR) service component, and the like. It may be understood that although a single service component is shown in FIG. 1, in practice, a plurality of service components may be installed on the component running platform 110. A plurality of service components may be integrated on the component running platform 110, which may be considered as a multifunction collaboration platform. In the case that a plurality of service components are installed in the component running platform 110, the plurality of service components may be integrated on one or more component running platforms 110. In the component running platform 110, people may start different service components according to the needs to complete corresponding information processing, sharing, communication and the like. The service component 125 may provide a content entity 126. The content entity 126 may be a content instance created by the user 140 or other users on the service component 125. For example, depending on the type of the service component 125, the content entity 126 may be unstructured content. For example, a document (e.g., a word document, a pdf document, a presentation, a table document, etc.), a email, a message (e.g., a conversation message on an instant messaging service component), a calendar, a schedule, a task, an audio, a video, an image, or the like. The content entity 126 may be structured content. For example, a data table, a form, or the like.

In some embodiments, the component running platform 110 may provide a digital assistant 120. The digital assistant 120 may be provided by a separate service component, or may be integrated into certain service component 125 capable of providing the content entity. The service component of the client interface for providing the digital assistant may correspond to a single function service component or a multifunction collaboration platform, such as an office suite or other collaboration platform capable of integrating a plurality of components. It may be understood that, similar to the service component, although a single digital assistant is shown in FIG. 1, there may actually be a plurality of digital assistants.

The component running platform 110 may be deployed locally at the terminal device of each user 140, and/or may be supported by a server device. For example, the terminal device of the user 140 may run the client with the component running platform 110, and the client may support the user 140 to interact with the component running platform 110 provided by the server. In a case that the component running platform 110 runs locally on the user's terminal device, the user 140 may directly interact with the local component running platform 110 by using the terminal device. In a case that the component running platform 110 runs at the server device, the server device may provide services for the client running in the terminal device based on the communication connection with the terminal device. The component running platform 110 may present a corresponding interface 150 to the user 140 based on the operation of the user 140 to output information related to component usage to the user 140 and or receive the information from the user 140.

In some embodiments, an implementation of at least part of the functionality of the service component 125, and/or an implementation of at least part of the functionality of the digital assistant 120 may be implemented based on a target model 155. During running process of the service component 125, one or more target models 155 may be invoked. The target model 155 may be used to understand the user input and provided services based on the output of the target model 155, such as providing a reply to the user.

Although shown as independent of the component running platform 110, one or more target models 155 may run on the component running platform 110, or other remote servers. In some embodiments, the target model 155 may be a machine learning model, a deep learning model, a learning model, a neural network, or the like. In some embodiments, the model may be based on a language model (LM). The language model can have question-answering capability by learning from a large corpus of corpora. The target model 155 may also be based on other suitable models.

The component running platform 110 may run on a suitable electronic device. The electronic device herein may be any type of device having computing capability, including a terminal device or a server device. The terminal device may be any type of mobile terminals, fixed terminals, or portable terminals, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. The server device may include, for example, a computing system/server, such as a mainframe, an edge computing node, a computing device in a cloud environment, or the like. In some embodiments, the component running platform 110 may be implemented based on the cloud services.

It should be understood that the structures and functions of the environment 100 are described for illustrative purposes only and do not imply any limitation to the scope of the present disclosure.

As briefly described above, there has been a demand for users to extract various content to the structured carrier. Taking an email as an example, there has long been a need for users to structurally extract mail contents to different carriers. Conventionally, a user usually organizes the data in the mail to different carriers by manually copying and pasting. This approach is inefficient and error-prone.

In view of this, embodiments of the present disclosure provide an improved solution for information extraction. According to various embodiments of the present disclosure, the component running platform determines the target content and the target structured data object based on the user input indicating the information extraction. Structured information of the target structured data object is obtained, where the structured information indicates at least one field comprised in the target structured data object. Then, the component running platform determines at least one data item from the target content based on the target content and the structured information, each data item corresponding to one or more fields in the target structured data object. In the target structured data object, the data items are respectively added to the corresponding one or more fields. Thereby, it is possible to help a user in more efficiently organizing the information in the target content into various structured carriers. For example, the information in the mail is organized into a table, a to-do list, a structured document, and so on.

Some example embodiments of the present disclosure will be described below with reference to the accompanying drawings. It should be understood that the interface shown in the drawings is merely an example, and in practice various interface designs may exist. Each graphical element in the interface may have different arrangements and different visual representations, one or more of graphical elements may be omitted or replaced, and one or more other elements may also exist. Embodiments of the present disclosure are not limited in this respect. Further, in the following, example embodiments will be described primarily with respect to the component running platform 110. It should be understood that actions described with respect to the component running platform 110 may be implemented by a client and/or a server of the component running platform 110. For example, the actions may be performed by an application, a component, or a suite (for example, the service component 125) running on the terminal device, or may be performed by an application, a component, or a suite in cooperation with a server thereof.

A solution for information extraction according to an embodiment of the present disclosure will be described below with reference to FIG. 2. FIG. 2 illustrates a schematic diagram of an example architecture 200 for information extraction according to some embodiments of the present disclosure. The following is described with reference to FIG. 1 for ease of discussion.

As shown in FIG. 2, the component running platform 110 determines a target content 212 and a target structured data object 211 based on a user input (e.g., from the user 140) indicating information extraction. The target content 212 is the content from which information is to be extracted. The target content 212 may be any suitable type of content, which may be unstructured content (e.g., a mail, a text document), or may be structured content (e.g., a data table, a form, etc.). In some examples, the target content 212 may include at least part of an email, a latest mail under a same topic, a text document, a chapter of a text, and/or the like.

The target structured data object 211 is a carrier in which the extracted information is to be written. The target structured data object may be any suitable type of object capable of structurally storing data, such as a data table, a key-value type database, or the like. In some examples, the target structured data object 211 may be an online data table, such as a multi-dimensional table managed by a component running platform. In some other examples, the target structured data object 211 may be a data table stored locally on a terminal device of the user 140 or a data table stored in other suitable devices. The component running platform determining the target content and the target structured data object will be described in detail below with two examples.

In some embodiments, the component running platform 110 obtains structured information of the target structured data object. The structured information obtained by the component running platform 110 is configured to indicate at least one field comprised in the target structured data object. For example, the target structured data object includes three fields: “commodity name”, “quantity”. “price”, and the like.

In the example of FIG. 2, the component running platform 110 may provide the target structured data object 211 to the server 213 to obtain the structured information 214. For example, the server 213 may be a server of the component running platform 110. The component running platform 110 obtains a structured field type of the target structured data object 211 through an application programming interface (API), for example, header information in a multi-dimensional table.

In some embodiments, the component running platform 110 determines at least one data item (also referred to as a target data item) from the target content based on the target content and the structured information. Each data item corresponds to one or more fields in at least one field, i.e., corresponds to one or more fields in the target structured data object 211. Continuing with the example above, a Bluetooth headset corresponds to the field “commodity name”, 123 corresponds to the field “number”, 12123 yuan corresponds to the field “price”. The Bluetooth speaker corresponds to the field “commodity name”, 44 corresponds to the field “number”, and 12843 yuan corresponds to the field “price”. That is, the component running platform 110 determines the information conforming to the structure of the target structured data object 211 from the target content 212 according to the target content 212 and the structured information 214.

In some embodiments, if the target content 212 itself is structured, such as another data table, the component running platform 110 may determine a data item conforming to the structure of the target structured data object 212 according to the structured information of the target content 202 (e.g., included fields).

In some embodiments, the component running platform 110 may determine the target data item with the target model. For example, if the target content 212 includes unstructured text content, the target model may be used to understand the text content, thereby extracting the target data item. For example, the component running platform 110 may generate prompt information (e.g., a prompt word) for the target model based on the target content and the structured information. Then, the component running platform 110 provides the prompt information to the target model to obtain an output of the target model, and determines at least one data item based on the output of the target model.

In some examples, as shown in FIG. 2, the component running platform 110 generates prompt information based on the target content 212 and the structured information 214. The component running platform 110 inputs the prompt information into the target model 155. The target model 155 may output at least one data item 215 or may output an intermediate result, and the component running platform 110 further determines the at least one data item 215 according to the output of the model. For example, the target model 155 generates key information that can match these fields by learning and understanding the structure of the fields of the target structured data object 211, and by analyzing the semantics of the target content 212 (e.g., mail content).

In some embodiments, the component running platform 110 adds the at least one data item to corresponding one or more fields in the target structured data object, respectively. In some examples, the component running platform 110 inputs the at least one data item 215 to the server 213, the server correspondingly writes the at least one data item 215 to one or more fields in the target structured data object 211.

For example, the component running platform 110 writes the information obtained by the target model 155 and the prompt information into the target structured data object 211 through the API interface. In this way, it may be ensured that the structured information 214 accurately matches one or more fields included in the target structured data object 211.

The component running platform 110 determining the target content and the target structured data objects is described below in an example and with reference to FIGS. 3A-3D. The target content may be a mail, a text, a data table, or the like, for example, extracting a document information to a table, and extracting table information to another table. The following is a description of taking the type of the target content as a mail as an example for ease of discussion, but this is merely exemplary, and is not limited in the present disclosure.

FIGS. 3A-3D illustrate schematic diagrams for designating target content and target structured data objects according to some embodiments of the present disclosure. The component running platform 110 receives an information extraction configuration from a user. The information extraction configuration received by the component running platform 110 is for a content set and is configured for indicating an extraction destination and a source content range in the content set.

In some embodiments, the component running platform 110 presents a configuration entry for information extraction in a content presentation interface associated with the content set. As shown in FIG. 3A, the component running platform 110 presents a configuration entry for information extraction (e.g., an extraction information control 310) on a presented content (e.g., mail) presentation interface 300A associated with a content set (e.g., a mail set).

In some embodiments, the component running platform 110 presents an extraction configuration interface for the content set in response to the configuration entry being triggered. The component running platform 110 then receives a user designation for the extraction destination and a user designation for the source content range via the extraction configuration interface.

As shown in FIG. 3B, the component running platform 110 presents the extraction configuration interface 320 in response to the user 140 clicking on the extraction information control 310. The component running platform 110 receives a designated source content range and a designated extraction destination input by the user 140. In some examples, the designated source content range input by the user 140 may be one or more chapters or pages of a latest mail, document, or text under a same topic. For example, the user 140 selects “latest mail under this topic” for selecting content to extract the mail.

In some examples, the extraction destination designated by the user 140 may be a target structured data object or a document directory. If the extraction destination input by the user 140 is a certain document directory, the target structured data object may be a data table under the directory. In the example of FIG. 2, the user 140 selects to extract to “XXX table” for the extraction destination. The user 140 clicks on the “confirm” control 321, and the running platform 110 receives the configuration information input by the user 140.

In some embodiments, the component running platform 110 determines the target structured data object based on the extraction destination. For example, based on the user 140 selecting to extract to “XXX table”, the “XXX table” is determined as the target structured data object. For another example, if the user 140 selects a certain document directory, the target structured data object may be each of the data table under the document directory.

In some embodiments, the component running platform 110 determines the target content from the content set based on the source content range. For example, based on the user 140 selecting “latest mail under this topic”, the content of the received latest email under the topic each time is determined as the target content.

In some embodiments, the component running platform 110 presents at least one data item and one or more fields corresponding to each data item. If the component running platform 110 receives a positive indication for at least one data item, at least one data item is added to the corresponding one or more fields, respectively.

As shown in FIG. 3C, the component running platform 110 presents its extracted information at the interface 300C. For example, the data items corresponding to the fields “commodity name”, “quantity” and “price” are extracted: “the quantity of the commodity named commodity A is 123 and the price is XX”, and “the quantity of the commodity named commodity B is 456 and the price is XXX”. If the user 140 clicks on the “confirm” control 331, the component running platform 110 adds its extracted data items to the corresponding fields, respectively.

The component running platform 110 presents “extracted to XXX table” control 340 at the interface 300D based on adding the data items to the corresponding fields, respectively. The user 140 may click the “extracted to XXX table” control to view the target structured data object updated by the component running platform 110 (e.g., XXX table).

In the above example, the target content and the target structured data object are designated by the user. In some embodiments, the target content and/or the target structured data object may not be designated by the user. For example, the user 140 may pre-designate or predetermine an information extraction rule for determining the target content and/or the target structured data object.

The component running platform 110 determining the target content and the target structured data objects will be described below with another example and with reference to FIGS. 4A-4C. The following description takes the target content as a mail as an example for ease of discussion, but this is merely exemplary, and is not limited in the present disclosure.

In some embodiments, the component running platform 110 receives, from a user, an information extraction rules for a predetermined type of content (e.g., mail). For example, the component running platform 110 receives a custom rule from the user 140 for the mail content, and the custom rule is used to automatically trigger the information extraction process.

In some embodiments, the information extraction rule indicates an information extraction condition and an extraction destination for the predetermined type of content. The component running platform 110 determines the candidate content satisfying the information extraction condition as the target content. Accordingly, the component running platform 110 determines the extraction destination as the target structured data object.

For ease of understanding, the following will refer to FIG. 4A to describe the rules for extracting information received by the component running platform. FIG. 4A illustrates a schematic diagram of an example interface for designating or setting information extraction rules according to some embodiments of the present disclosure.

As shown in FIG. 4A, the component running platform 110 may present the information extraction rule setting interface 400A on the terminal device of the user 140, so that the user 140 sets the information extraction rule. The information extraction rule includes an extraction condition 410 and an extraction destination 412.

In some embodiments, the information extraction conditions may include a condition(s) for entities related to the predetermined type of content. For example, “the mail contains a certain sender”, “the mail contains a creator of a certain document”, and so on. The information extraction conditions may also include a condition(s) for semantics of the predetermined type of content. For example, “a theme of a certain document contained in a mail”, “the type of the mail is a certain type”, and so on.

In some examples, the user 140 sets the extraction condition 410 and the extraction destination 412 at the interface 400A. For example, the user 140 sets the extraction condition as “the mail contains a certain sender, and the content is an X type mail”. The user 140 sets the extraction destination 412 at the interface 400A. In this case, if the user 140 clicks the “save rule” control 413, the component running platform 110 saves the information extraction rule set by the user 140, and automatically triggers the information extraction process based on the rule. It should be understood that this is merely for example, and the user 140 may also set or designate the target content.

In some examples, if the component running platform 110 determines that the candidate content (e.g., the content of the latest email) satisfies the extraction condition 410 set by the user 140, the candidate content may be determined as the target content for extracting the information therefrom to the extraction destination 412 (e.g., “XXX table”).

FIG. 4B illustrates a schematic diagram of an architecture example 400B for information extraction according to some other embodiments of the present disclosure. As shown in FIG. 4B, the component running platform 110 determines the content conforming to the information extraction rule 421 from the candidate content 420 as the target content based on the information extraction rule 421 set by the user 140 (for example, the custom rule).

In some examples, if the information extraction rule 421 involves a user-defined fixed rule 422 (e.g., the mail content contains a certain sender), then the component running platform 110 determines whether it is the target content according to the information extraction rule 421.

In some examples, if the information extraction rule 421 involves a user-defined broad condition 423 (for example, a rule that requires understanding the content), the component running platform 110 may perform semantic recognition on the candidate content by using the target model 155, and further determine whether the candidate content is the target content. For example, if the information extraction rule 421 includes “the mail content is a mail type about the customer complaint”, it is necessary to understand the mail content.

If the component running platform 110 determines that the candidate content 420 satisfies the information extraction rule 421, the information extraction process may be automatically triggered, for example, referring to the process described with reference to FIG. 2. That is, the component running platform 110 obtains the structured information of the target structured data object. The component running platform 110 determines at least one data item from the target content based on the target content and the structured information, each data item corresponding to one or more fields in the at least one field. The component running platform 110 then adds at least one data item to the corresponding one or more fields in the target structured data object, respectively.

In some embodiments, the component running platform 110 presents, in an interaction interface between the user and the digital assistant, prompt information for extracting information from the target content to the target structured data object. FIG. 4C illustrates a schematic diagram 400C for presenting prompt information for target content extraction information to a target structured data object according to some embodiments of the present disclosure.

As shown in FIG. 4C, the component running platform 110 presents prompt information 432 for extracting information from the target content to the target structured data object in an interaction interface 431 between the user 140 and the digital assistant 120. For example, the component running platform 110 presents prompt information from the digital assistant 120: “Hello, you have just received a “XXX” email, I have helped you to extract the “XXX” information into the “XXX” data table”.

In summary, with the embodiments of the present disclosure, content (for example, mail content) can be efficiently extracted into different data tables, and manual work is reduced. Furthermore, the method is suitable for automatic structured extraction of different scenes, and improves the working efficiency. Through the information extraction rule, the conditional triggering mechanism is implemented, so that the personalized requirement of the user for automatic extraction is satisfied, and the user use process is simplified.

### Example Process, Apparatus, and Device

FIG. 5 illustrates a flowchart of a process 500 for information extraction according to some embodiments of the present disclosure. The process 500 may be implemented at the component running platform 110, for example, by a server of the service component 125, or by a terminal device of the service component 125, or by the server and the terminal device in coordination. The process 500 is described below with reference to FIG. 1.

At block 510, the component running platform 110 determines the target content and the target structured data object based on the user input indicating the information extraction.

At block 520, the component running platform 110 obtains structured information of the target structured data object, the structured information indicating at least one field comprised in the target structured data object.

At block 530, the component running platform 110 determines at least one data item from the target content based on the target content and the structured information. Each data item corresponds to one or more fields in the at least one field.

At block 540, the component running platform 110 adds the at least one data item to corresponding one or more fields in the target structured data object, respectively.

In some embodiments, determining the target content and the target structured data object comprises: receiving, from the user, an information extraction configuration for the content set, the information extraction configuration indicating an extraction destination and a source content range in the content set; determining the target structured data object based on the extraction destination; and determining the target content from the content set based on the source content range.

In some embodiments, receiving the information extraction configuration for the content set comprises: presenting, in a content presentation interface associated with the set of content, a configuration entry for information extraction; in response to the configuration entry being triggered, presenting an extraction configuration interface for the content set; and receiving, via the extraction configuration interface, a user designation for the extraction destination and a user designation for the source content range.

In some embodiments, adding the at least one data item to the corresponding one or more fields respectively comprises: presenting the at least one data item and one or more fields corresponding to each data item; and in response to receiving a positive indication for the at least one data item, adding the at least one data item to the corresponding one or more fields respectively.

In some embodiments, determining the target content and the target structured data object comprises: receiving, from the user, an information extraction rule for the predetermined type of content, the information extraction rule indicating an information extraction condition and an extraction destination for the predetermined type of content; determining candidate content satisfying the information extraction condition as the target content; and determining the target structured data object based on the extraction destination.

In some embodiments, the information extraction condition comprises at least one of: a condition for an entity related to the predetermined type of content, or a condition for semantics of the predetermined type of content.

In some embodiments, the process 500 further comprises: presenting, in an interaction interface between the user and a digital assistant, prompt information for extracting information from the target content to the target structured data object.

In some embodiments, determining the at least one data item from the target content comprises: generating, based on the target content and the structured information, prompt information for a target model; providing the prompt information to the target model to obtain an output of the target model; and determining the at least one data item based on the output of the target model.

In some embodiments, the target content comprises at least part of a mail.

FIG. 6 illustrates a schematic structural block diagram of an apparatus 600 for information extraction according to some embodiments of the present disclosure. The apparatus 600 may be implemented as the component running platform 110 or may be included in the component running platform 110. The various modules/components in the apparatus 600 may be implemented by hardware, software, firmware, or any combination thereof.

As shown, the apparatus 600 comprises a determining module 610 configured to determine, based on a user input indicating information extraction, a target content and a target structured data object. The apparatus 600 further comprises an information obtaining module 620 configured to obtain structured information of the target structured data object, the structured information indicating at least one field comprised in the target structured data object. The apparatus 600 further comprises a data item determination module 630 configured to determine, based on the target content and the structured information, at least one data item from the target content, the data item corresponding to one or more fields in the at least one field. The apparatus 600 further comprises a data item adding module 640 configured to add the at least one data item to corresponding one or more fields in the target structured data object, respectively.

In some embodiments, the determining module 610 is further configured to receive, from a user, an information extraction configuration for a content set, the information extraction configuration indicating an extraction destination and a source content range in the content set; determine the target structured data object based on the extraction destination; and determine the target content from the content set based on the source content range.

In some embodiments, the determination module 610 further comprises an information receiving module configured to present a configuration entry for information extraction in a content presentation interface associated with the content set; in response to the configuration entry being triggered, present an extraction configuration interface for the content set; and receive, via the extraction configuration interface, a user designation for the extraction destination and a user designation for the source content range.

In some embodiments, the data item adding module 640 is further configured to present the at least one data item and one or more fields corresponding to each data item; and in response to receiving a positive indication for the at least one data item, add the at least one data item to the corresponding one or more fields respectively.

In some embodiments, the determining module 610 is further configured to receive, from a user, an information extraction rule for a predetermined type of content, the information extraction rule indicating an information extraction condition and an extraction destination for the predetermined type of content; determine candidate content satisfying the information extraction condition as the target content; and determine the target structured data object based on the extraction destination.

In some embodiments, the information extraction condition comprises at least one of: a condition for an entity related to the predetermined type of content, or a condition for semantics of the predetermined type of content.

In some embodiments, the apparatus 600 further comprises a prompt information presenting module configured to present, in an interaction interface between the user and the digital assistant, prompt information for extracting information from the target content to the target structured data object.

In some embodiments, the data item determination module 630 is further configured to generate, based on the target content and the structured information, prompt information for a target model; provide the prompt information to the target model to obtain an output of the target model; and determine the at least one data item based on the output of the target model.

In some embodiments, the target content comprises at least part of a mail.

FIG. 7 illustrates a block diagram of an electronic device 700 capable of implementing one or more embodiments of the present disclosure. It should be understood that the electronic device 700 illustrated in FIG. 7 is merely an example and should not constitute any limitation on the function and scope of the embodiments described herein. The electronic device 700 shown in FIG. 7 may be configured to implement the component running platform 110 in FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in the memory 720. In multiprocessor systems, a plurality of processing units execute computer-executable instructions in parallel to improve parallel processing capabilities of electronic device 700.

The electronic device 700 typically includes a plurality of computer storage media. Such media may be any available media accessible by the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the disclosure.

The communications unit 740 implements communications with other electronic devices over a communications medium. Additionally, the functionality of components of the electronic device 700 may be implemented in a single computing cluster or a plurality of computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, external devices such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, the computer-executable instructions being executed by a processor to implement the method described above.

Aspects of the disclosure are described herein with reference to flowcharts and/or block diagrams of methods, apparatuses, devices, and computer program products implemented based on the disclosure. It should be understood that each block of the flowchart and/or block diagram, and combinations of blocks in the flowcharts and/or block diagrams, may be implemented by computer-readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce apparatus to implement the functions/acts specified in the flowchart and/or block(s) in block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer-readable program instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

What is claimed is:

1. A method for information extraction, comprising:
determining, based on a user input indicating information extraction, a target content and a target structured data object;
obtaining structured information of the target structured data object, the structured information indicating at least one field comprised in the target structured data object;
determining, based on the target content and the structured information, at least one data item from the target content, the at least one data item corresponding to one or more fields in the at least one field; and
adding the at least one data item to corresponding one or more fields in the target structured data object, respectively.

2. The method of claim 1, wherein determining the target content and the target structured data object comprises:
receiving, from a user, an information extraction configuration for a content set, the information extraction configuration indicating an extraction destination and a source content range in the content set;
determining the target structured data object based on the extraction destination; and
determining the target content from the content set based on the source content range.

3. The method of claim 2, wherein receiving the information extraction configuration for the content set comprises:
presenting a configuration entry for information extraction in a content presentation interface associated with the content set;
in response to the configuration entry being triggered, presenting an extraction configuration interface for the content set; and
receiving, via the extraction configuration interface, a user designation for the extraction destination and a user designation for the source content range.

4. The method of claim 2, wherein adding the at least one data item to the corresponding one or more fields respectively comprises:
presenting the at least one data item and one or more fields corresponding to each data item; and
in response to receiving a positive indication for the at least one data item, adding the at least one data item to the corresponding one or more fields respectively.

5. The method of claim 1, wherein determining the target content and the target structured data object comprises:
receiving, from a user, an information extraction rule for a predetermined type of content, the information extraction rule indicating an information extraction condition and an extraction destination for the predetermined type of content;
determining candidate content satisfying the information extraction condition as the target content; and
determining the target structured data object based on the extraction destination.

6. The method of claim 5, wherein the information extraction condition comprises at least one of:
a condition for an entity related to the predetermined type of content, or
a condition for semantics of the predetermined type of content.

7. The method of claim 1, further comprising:
presenting, in an interaction interface between a user and a digital assistant, prompt information for extracting information from the target content to the target structured data object.

8. The method of claim 1, wherein determining the at least one data item from the target content comprises:
generating, based on the target content and the structured information, prompt information for a target model;
providing the prompt information to the target model to obtain an output of the target model; and
determining the at least one data item based on the output of the target model.

9. The method of claim 1, wherein the target content comprises at least part of a mail.

10. An electronic device comprising:
at least one processing unit; and
at least one memory coupled to the at least one processing unit and storing instructions for execution by the at least one processing unit, wherein the instructions, when executed by the at least one processing unit, cause the electronic device to perform acts comprising:
determining, based on a user input indicating information extraction, a target content and a target structured data object;
obtaining structured information of the target structured data object, the structured information indicating at least one field comprised in the target structured data object;
determining, based on the target content and the structured information, at least one data item from the target content, the at least one data item corresponding to one or more fields in the at least one field; and
adding the at least one data item to corresponding one or more fields in the target structured data object, respectively.

11. The electronic device of claim 10, wherein determining the target content and the target structured data object comprises:
receiving, from a user, an information extraction configuration for a content set, the information extraction configuration indicating an extraction destination and a source content range in the content set;
determining the target structured data object based on the extraction destination; and
determining the target content from the content set based on the source content range.

12. The electronic device of claim 11, wherein receiving the information extraction configuration for the content set comprises:
presenting a configuration entry for information extraction in a content presentation interface associated with the content set;
in response to the configuration entry being triggered, presenting an extraction configuration interface for the content set; and
receiving, via the extraction configuration interface, a user designation for the extraction destination and a user designation for the source content range.

13. The electronic device of claim 11, wherein adding the at least one data item to the corresponding one or more fields respectively comprises:
presenting the at least one data item and one or more fields corresponding to each data item; and
in response to receiving a positive indication for the at least one data item, adding the at least one data item to the corresponding one or more fields respectively.

14. The electronic device of claim 10, wherein determining the target content and the target structured data object comprises:
receiving, from a user, an information extraction rule for a predetermined type of content, the information extraction rule indicating an information extraction condition and an extraction destination for the predetermined type of content;
determining candidate content satisfying the information extraction condition as the target content; and
determining the target structured data object based on the extraction destination.

15. The electronic device of claim 14, wherein the information extraction condition comprises at least one of:
a condition for an entity related to the predetermined type of content, or
a condition for semantics of the predetermined type of content.

16. The electronic device of claim 10, further comprising:
presenting, in an interaction interface between a user and a digital assistant, prompt information for extracting information from the target content to the target structured data object.

17. The electronic device of claim 10, wherein determining the at least one data item from the target content comprises:
generating, based on the target content and the structured information, prompt information for a target model;
providing the prompt information to the target model to obtain an output of the target model; and
determining the at least one data item based on the output of the target model.

18. The electronic device of claim 10, wherein the target content comprises at least part of a mail.

19. A non-transitory computer readable storage medium having a computer program stored thereon, the computer program being executable by a processor to perform acts comprising:
determining, based on a user input indicating information extraction, a target content and a target structured data object;
obtaining structured information of the target structured data object, the structured information indicating at least one field comprised in the target structured data object;
determining, based on the target content and the structured information, at least one data item from the target content, the at least one data item corresponding to one or more fields in the at least one field; and
adding the at least one data item to corresponding one or more fields in the target structured data object, respectively.

20. The non-transitory computer readable storage medium of claim 19, wherein determining the target content and the target structured data object comprises:
receiving, from a user, an information extraction configuration for a content set, the information extraction configuration indicating an extraction destination and a source content range in the content set;
determining the target structured data object based on the extraction destination; and
determining the target content from the content set based on the source content range.
